(19) United States
(12) Patent Application Publication
(10) Pub. No.: US 2006/0066088 A1
(43) Pub. Date: Mar. 30, 2006

(54) INFLATABLE AIRBAG CUSHION FORMED WITH A BLOWN ELASTOMER CORE AND METHODS OF USING AND MANUFACTURING SAME

(76) Inventors: Michael J. Hier, Royal Oak, MI (US); Glenn A. Cowelchuk, Chesterfield Township, MI (US); David Dooley, Troy, MI (US); Todd L. DePue, Brighton, MI (US); Randy S. Reed, Fair Haven, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/711,692

(22) Filed: Sep. 30, 2004

(51) Int. Cl. B60R 21/22

(52) U.S. Cl. 280/743.1; 280/731; 280/732

(57) ABSTRACT

An automotive interior component including a substrate adapted to be mounted inside a passenger cabin of a vehicle and a covering on at least a portion of the substrate adapted to define an airbag cushion deployed as a passenger restraint in the event of a collision. The covering includes a core of a cellular material that loses cohesion when an inflation fluid is injected to define a space between a substrate and an elastic outer layer. As the space fills with inflation fluid, the outer layer elastically expands for defining the airbag cushion. The automotive interior component may be made in a multi-shot molding operation with the substrate being formed in one shot and the covering being formed in another shot.

### FIELD OF THE INVENTION

The present invention relates generally to automotive interior components and, more particularly, to inflatable airbag cushions for a vehicle airbag system.

### BACKGROUND OF THE INVENTION

Motor vehicles include an airbag system consisting of impact sensors, a system controller, an inflator, and the inflatable airbag cushions themselves. The inflatable air bag cushions are stored for deployment at a number of locations inside a motor vehicle and, when deployed into the passenger cabin in the event of a collision, protect the vehicle occupants from injury. For example, inflatable airbag cushions are stored in compartments at concealed locations behind deployment doors within the steering wheel for protection of the driver and in the dashboard for protection of a passenger during a collision event.

Concealing each airbag cushion is a deployment door that forms an interior portion of the vehicle, such as a portion of the steering wheel hub or the dashboard. The deployment door covers an opening through which the airbag cushion is deployed in the event of a collision. When the airbag cushion inflates, the deployment door is opened by the force applied by the inflating airbag cushion against the deployment door. Tear lines or score lines are commonly provided in the deployment door so that the door material tears or rips along these lines of weakness. The door ruptures and pivots open so that the airbag can easily escape its compartment.

When the impact sensors of the airbag system detect the occurrence of a predetermined level of vehicle deceleration or other measurable vehicle condition as experienced during a collision, the inflator rapidly discharges an inflation fluid, such as high pressure gas or the like, into the airbag cushions under the control of the system controller. The rapid introduction of the inflation fluid causes the airbag cushions to rapidly expand. Each airbag cushion exerts an outwardly force against the deployment door directed into the passenger cabin, which causes the deployment door to open so that the inflating airbag cushion deploys into the passenger cabin. After entering the passenger cabin, the airbag cushions continue to expand as they fill with inflation fluid to provide restraints between the driver and passengers and fixed objects inside the passenger cabin, like the dashboard, steering wheel and windshield.

It would be desirable to provide an airbag cushion and manufacturing method that reduces the number of parts and the labor required for assembly thereof thereby reducing overall manufacturing costs.

### SUMMARY OF THE INVENTION

In an embodiment of the invention, an automotive interior component includes a substrate adapted to be mounted inside a passenger cabin of a vehicle and a covering on at least a portion of the substrate. The covering includes an elastic outer layer of a polymer material and a core of a polymer material having a cellular structure positioned between the outer layer and the substrate. The cellular structure of the core is configured to lose cohesion upon receipt of the inflation fluid to define a space between the outer layer and the substrate. The space fills with the inflation fluid to cause elastic expansion of the outer layer for defining an airbag cushion.

In another aspect of the invention, a method of manufacturing an inflatable airbag cushion for use as an automotive interior trim component includes injection molding a first polymer to form a substrate and then injection molding a second polymer to form a covering across a surface of the substrate to define the inflatable airbag cushion. The covering includes an elastic outer layer of the second polymer and a core of the second polymer having a cellular structure positioned between the substrate and the outer layer.

In another embodiment of the invention, a method of restraining an occupant of a vehicle passenger cabin comprises detecting an occurrence of a measurable vehicle condition and discharging an inflation fluid into a core of a covering on a substrate located inside the vehicle passenger cabin in response to the measurable vehicle condition so that the core loses cohesion and defines a space between the substrate and an elastic outer skin of the covering. The method further filling the space with the inflation fluid so that the outer skin elastically expands into the vehicle passenger cabin to define an inflated airbag cushion at a position that restrains the occupant.

The invention therefore provides an inflatable airbag cushion, and a method of making the same, that reduces the number of parts and the labor required for assembly. The outer skin provides an aesthetically pleasing appearance and lacks weakened regions, such as visible score lines and seams.

These and other objects and advantages of the invention shall become more apparent from the accompanying drawings and description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a diagrammatic view of a passenger cabin incorporating airbag cushions in accordance with the invention;

FIG. 1A is a diagrammatic view similar to FIG. 1 in which the airbag cushions are in an inflated condition precipitated by a collision;

FIG. 2A is a diagrammatic cross-sectional view taken generally along line 2A-2A in FIG. 1;

FIGS. 2B and 2 Care diagrammatic cross-sectional views similar to FIG. 2A depicting the inflation of the airbag cushion installed in the steering wheel in the event of a collision;

FIG. 2D is a diagrammatic cross-sectional view depicting the inflation of the airbag cushion in the dashboard in the event of a collision; and

FIGS. 3A-3D are diagrammatic cross-sectional views of an injection molding operation for forming the airbag cushions of FIG. 1.

### DETAILED DESCRIPTION

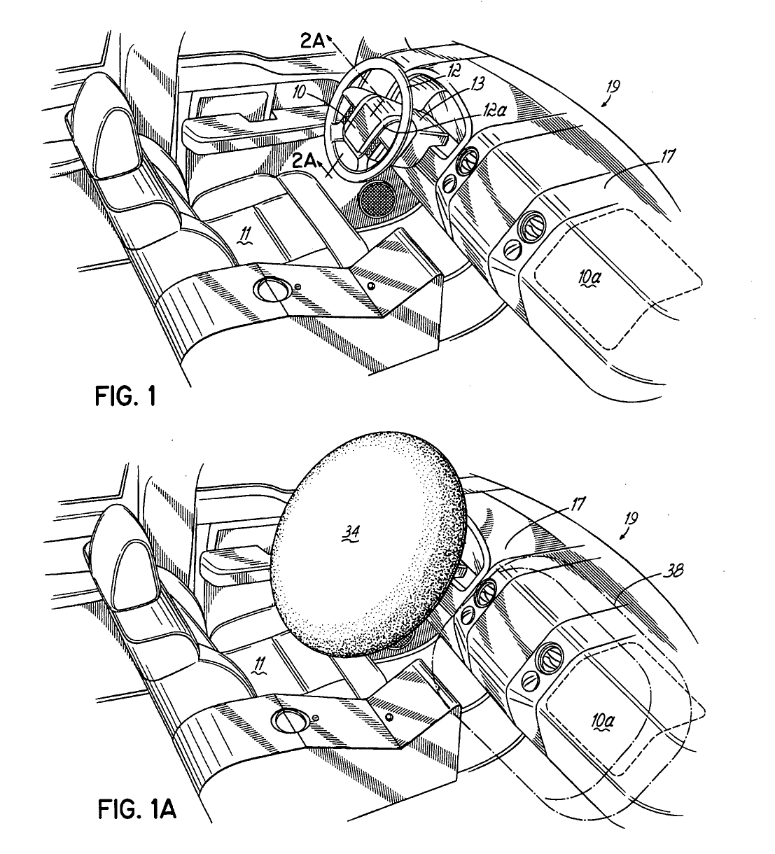

With reference to FIG. 1, an automotive interior component and, in particular, a trim panel 10 is installed in the hub 12a of a steering wheel 12 inside a passenger cabin 19 of a vehicle, such as, for example, an automobile or a truck. A driver seated in a driver's seat 11 operates the steering wheel 12 to actuate steering element for guiding the vehicle's direction of movement. The steering wheel 12 is installed on a steering column 13 that further includes components (not shown) like a steering shaft, an ignition key mechanism, and associated parts. Another trim panel 10a, substantially identical to trim panel 10, is installed in a vehicle dashboard 17 and is located in front of a passenger seat (not shown) located inside the passenger cabin 19 and flanking the driver's seat 11. The invention contemplates that trim panel 10 may be an integral portion of the steering wheel 12 and, similarly, trim panel 10a may be an integral portion of the dashboard 17.

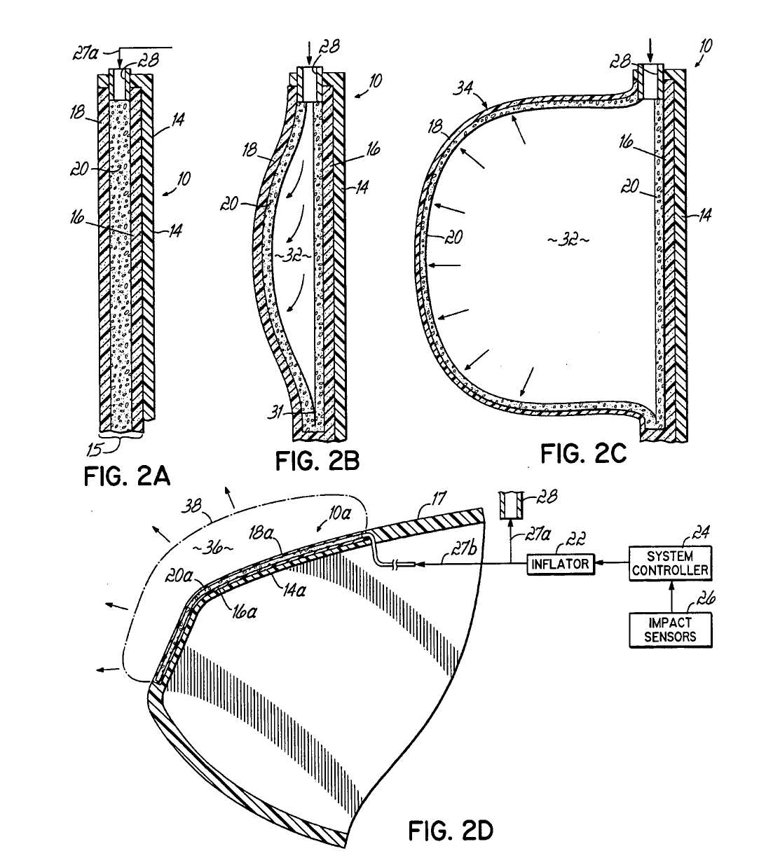

With reference to FIG. 2A, trim panel 10 is formed from a rigid substrate 14 and a covering 15 that is coupled by molding with the substrate 14. The covering 15 includes an inner layer or skin 16 coextensive with the substrate 14, a continuous outer layer or skin 18, and a core 20 of a cellular material, preferably with a closed cellular structure, disposed between the inner and outer skins 16, 18. Alternatively, the cells of the core 20 may define an interconnected open-cell structure. Outer skin 18 has an exterior surface that is exposed and visible to vehicle occupants seated inside the passenger cabin 19 when trim panel 10 and steering wheel hub 12a are assembled as a component part of an automobile. The inner skin 16 may operate as a tie layer with the substrate 14. The covering 15 may be present across the full dimensions of the substrate 14 or a portion of the substrate 14. Typically, the appearance of the outer skin 18 is aesthetically pleasing and will match the appearance of the steering wheel hub 12a (FIG. 1A).

The trim panel 10 is molded as a layered structure of different polymer materials by a multi-shot molding process, as described below. The substrate 14 is made from a structurally rigid thermoplastic or thermoset polymer material like polypropylene, styrene maleic anhydride, acrylonitrile-butadiene styrene/polycarbonate, and the like. The cellular material of the core 20 is composed of a thermoplastic polymer like a thermoplastic elastomer (TPE) compound or a polyolefin such as polypropylene. Trim panels similar to trim panels 10, 10a may be provided as a separate component part of other interior trim components to define integrated airbag cushion structures.

The layered structure of the outer skin 18 and core 20 defines a latent airbag cushion capable of being inflated by an inflation fluid, such as high pressure gas or another suitable inflation medium, provided via one branch 27a of a bifurcated supply line from an inflator 22 (FIG. 2D), as is well known to persons of ordinary skill in the art. The inflator 22 may contain an ignitable gas-generating material which, when ignited, rapidly generates a large volume of gas that serves as an inflation fluid or, alternatively, a stored quantity of pressurized inflation fluid. Impact sensors 26 (FIG. 2D) trigger a system controller 24 (FIG. 2D) to supply an appropriate inflation command signal to the inflator 22 upon detecting the occurrence of a predetermined level of vehicle deceleration or other measurable vehicle condition, as experienced during a collision. The system controller 24 includes electrical circuitry coupled with a power source, like the vehicle battery, the impact sensors 26, and the inflator 22.

An opening 28 defined in the core 20 is coupled by branch 27a of the supply line with inflator 22 (FIG. 2D), for receiving the inflation fluid and directing the inflation fluid into the core 20. Alternatively, the opening 28 may be provided on a structure that pierces the substrate 14 in the event of a collision to define a path into the core 20 for the inflation fluid. When the inflation fluid is supplied from the inflator 22 to the core 20, the cellular material constituting the core 20 will suffer a loss of cohesion and split apart longitudinally along a plane substantially parallel to, and confined between, the inner and outer skins 16, 18. The outer skin 18 and any portions of core 20 adhered to outer skin 18 after splitting will elastically expand and deform to accommodate the continued introduction of the inflation fluid. The inner skin 16 will remain attached to the substrate 14, which maintains the covering 15 attached to the substrate 15. Properties of the cellular material, like cell size, cell orientation, cell shape, etc., may be adjusted to determine the ability of the core 20 to shear and separate under the influence of the flow of high pressure inflation fluid.

With reference to FIGS. 1, 1A and 2A-D, the operation of the trim panels 10, 10a for providing safety cushions to protect the driver and passenger seated in the passenger cabin 19 in the event of a collision will be described. The trim panels 10, 10a are in a latent state under normal driving conditions, as shown in FIGS. 1A and 2A, with the covering 15 intact and un-inflated. When the impact sensors 26 of the airbag system detect a predetermined level of vehicle deceleration or other measurable vehicle condition as experienced in the event of a collision, the system controller 24 is triggered to send a command signal to the inflator 22. The electrically activated inflator 22 rapidly discharges a large volume of inflation fluid into the core 20 through opening 28 under the control of the system controller 24.

As shown in FIG. 2B, the rapid introduction of inflation fluid causes a shear plane 31 to initiate within the cellular material of the core 20 of the trim panels 10 and to propagate laterally between the inner and outer skins 16, 18. As the shear plane 31 propagates, the outer skin 18 and remnants of core 20 rapidly expand outwardly into the passenger cabin 19. This outward expansion of the outer skin 18 relative to the substrate 14 defines a space 32 between the inner and outer skins 16, 18 that fills with inflation fluid and operates as an airbag cushion 34 for the driver. The boundaries of the trim panel 10 close the periphery of the space 32, which are defined by polymer portions joining the inner and outer skins 16, 18 and delimit the extent of the airbag cushion 34. The inner skin 16 operates to retain the airbag cushion 34 to the steering wheel 12.

In response to the collision event, a similar activation sequence occurs with regard to an airbag cushion 38 deploying into the passenger cabin 19. Specifically, airbag cushion 38 is the result of inflation fluid, which is supplied via branch 27b of the supply line from inflator 22, forming and filling a space 36 (FIG. 2D) defined inside trim panel 10a. The inflation fluid causes loss of cohesion inside core 20a of trim panel 10a and the outward expansion of the outer skin 18a relative to substrate 14a. The inner skin 16a operates to keep the outer skin 18a secured to the substrate 14a during inflation.

As shown in FIGS. 1A and 2C, the outer skin 18 of the covering 15 is highly elastic and flexible so that the pressurized inflation fluid enlarges the space 32. The expanding airbag cushion 34 defined by the inflating space 32 defines a collision restraint between the driver and steering wheel 12. Similarly and as shown in FIG. 2D, the expanding airbag cushion 38 defined by the inflating space 36 defines a collision restraint between a vehicle passenger and the dashboard 17 and windshield of the vehicle.

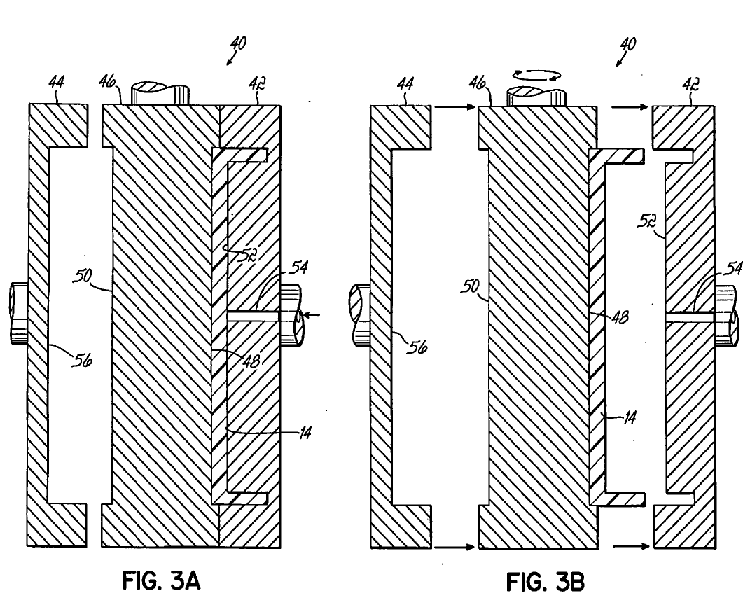

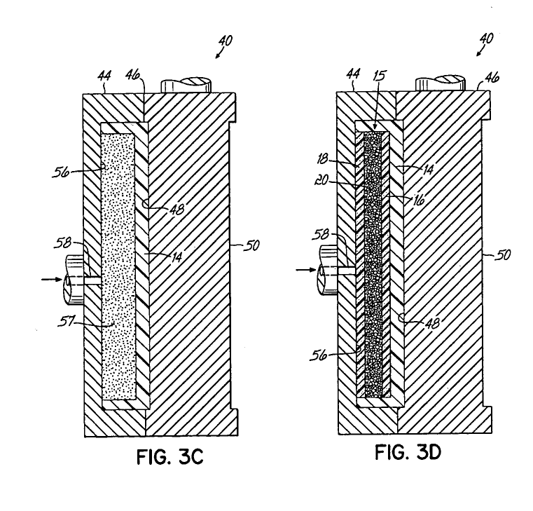

With reference to FIGS. 3A-D, a method of making the trim panel 10 of the present invention with a multi-shot process in an injection molding machine equipped with two independent injection systems for injecting different types of molten polymers will now be described.

With specific reference to FIG. 3A, a single mold assembly 40 includes spaced-apart first and second members 42 and 44 and a core 46 situated between the members 42, 44. The core 46 has opposite first and second cavities 48 and 50 each adapted to confront and mate with one of a corresponding first and second cavities 52, 56 defined in the members 42, 44. The core 46 is adapted to pivot so that the first and second cavities 48, 50 are confronting, in turn, with the first and second cavities 52, 56 for injection molding, in sequence, first the substrate 14, then the covering 15. While the first and second shots of the injection molding operation are described below with respect to the first cavity 48, it is understood that the first and second shots of the two-shot molding operation occur in the same fashion with respect to the second cavity 50. In addition, the injection molding process described below for trim panel 10 applies equally to the injection molding process for forming trim panel 10a. As mentioned above, the trim panels 10, 10a could be formed integrally with larger structures inside passenger cabin 19 (FIG. 1), such as the steering wheel 12, the instrument panel, or the dashboard 17.

With reference to FIG. 3A, the first cavity 48 of the core 46 is moved into alignment with mold cavity 52 and mated with the first member 42 to define a closed first shot chamber defined by the combined volume of cavities 48 and 52. In a first shot of the molding operation, a molten polymer suitable for forming substrate 14 is injected through a channel 54 into the first shot chamber. It should be understood, as indicated above, that the substrate 14 for the airbag cushion may be injection molded by the methods disclosed herein as an integral part of a larger structure, such as steering wheel hub 12a or dashboard 17.

With reference to FIGS. 3B and 3C, the first member 42 is moved away from the core 46 and core 46 is rotated so that the first cavity 48 carrying substrate 14 confronts and mates with the second cavity 56 to define a closed second shot chamber about the substrate 14 (FIG. 3C). In a second shot of the two-shot molding operation, a molten polymer material 57 is injected through a channel 58 into the second shot chamber to form the covering 15.

The injected molten polymer is activated, or foamed, as is commonly known in the art, by introducing a physical or chemical blowing agent into the molten polymer provided to the second shot chamber. Generally, the blowing agent works by expanding the polymer of core 20 to produce a cellular structure having significantly less density than the polymer itself. The blowing agent may be any chemical agent that liberates gas when heated above a characteristic decomposition temperature (e.g., sodium bicarbonate that liberates CO₂ when heated above its decomposition temperature), any physical agent such as any gas (e.g., gaseous nitrogen), or any other known blowing agent. As the polymer cools and hardens, gas-filled bubbles originating from the blowing agent define the cellular structure throughout core 20 of a given density. Depending upon the molding conditions, the cell structure of the cured core 20 may either be closed or open. The polymer material of covering 15 may be a thermoplastic polymer like a thermoplastic elastomer or a polyolefin like polypropylene.

With reference to FIG. 3D, as the mold is cooled, portions of the molten polymer in contact with the cavity wall of the second member 44 and in contact with the substrate 14 held by the first cavity 48 form the inner skin 16 on the surface of substrate 14 and the outer skin 18 on the exposed surface of the finished trim panel 10. The skins 16, 18 are substantially free of the cells found in core 20 and, therefore, have a greater density than the core 20. The thickness of the skins 16, 18 is dependent upon the cooling rate of the surfaces of the molten polymer that are in contact with the second shot mold cavity 56 and the substrate 14. Cooling the molten polymer more rapidly increases the thickness of the skins 16, 18.

After the trim panel 10 has cooled, the second member 44 is moved away from the core 46, and the trim panel 10 is ejected, such as by ejector pins (not shown), from the first cavity 48. The inner skin 16 is bonded, or integrally molded, with the substrate 14, and the inner and outer skins 16, 18 and foam core 20 are bonded or integrally molded with each other so that the substrate 14 and covering 15 define an integral structure. In addition, the core 20 of the trim panel 10 includes the cellular structure. The two-shot molding process is repeated to form additional trim panels 10. Opening 28 may be provided by a post-molding operation.

Although not illustrated, it is understood that the second cavity 50 also is adapted to confront and mate with the first member 42, during the mating of the first cavity 48 with the second member 44, to form a second substrate (not shown) identical to the first substrate 14 by injecting molten polymer into the first shot chamber defined by cavities 50 and 52 in the first shot of the molding operation. After injection, the core 46 is rotated to align the second cavity 50 with cavity 56 in the second member 44 and mated to define a second shot chamber for the second shot of the molding operation while the first cavity 48 returns to a confronting relationship with cavity 52 in the first member 42 to repeat the first shot of the molding operation. In this fashion, multiple trim panels 10 may be serially formed in a continuous and efficient manner.

Trim panels 10, 10a or, at the least, coverings 15, 15a may also be formed by other multi-component molding processes known to those skilled in the art. For example, covering 15 may be formed by a co-injection molding process in which two or more molten polymers are sequentially or simultaneously injected into the same mold to form skin layers 16, 18 from one injected polymer and the cellular core 20 from a different injected polymer.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

What is claimed is:

1. An automotive interior component providing an airbag cushion capable of being filled by an inflation fluid to restrain an occupant inside a passenger cabin of a vehicle, comprising:
a substrate adapted to be mounted inside the passenger cabin; and
a covering on at least a portion of said substrate, said covering including an elastic outer layer of a polymer material and a core of said polymer material having a cellular structure positioned between said outer layer and said substrate, said cellular structure of said core configured to lose cohesion upon receipt of the inflation fluid for defining a space between said outer layer and said substrate, and said space filling with the inflation fluid to cause elastic expansion of said outer layer for defining the airbag cushion.

2. The automotive interior component of claim 1 wherein said substrate includes a material selected from the group consisting of a thermoplastic polymer and a thermoset polymer.

3. The automotive interior component of claim 1 wherein said polymer material forming said covering is selected from the group consisting of a thermoplastic elastomer compound and a polyolefin.

4. The automotive interior component of claim 1 further comprising:
an inner layer of said polymer material having said substantially non-cellular structure positioned between said core and said substrate, said inner layer remaining attached to said substrate after inflation of said space to define the airbag.

5. The automotive interior component of claim 1 wherein said covering and said substrate define a unitary molded assembly.

6. The automotive interior component of claim 5 wherein said substrate is formed by a first shot of a two-shot molding process and said covering is formed by a second shot of the two-shot molding process.

7. The automotive interior component of claim 1 wherein said core includes an opening defining a pathway for inflation fluid supplied from an inflation fluid source.

8. The automotive interior component of claim 1 wherein said core is less dense than said outer skin.

9. The automotive interior component of claim 1 wherein said polymer material in said outer layer is non-cellular.

10. A method of manufacturing an inflatable airbag cushion for use as an automotive interior component, comprising:
injection molding a first polymer to form a substrate; and
injection molding a second polymer to form a covering across a surface of the substrate to define the inflatable airbag cushion, the covering including a elastic outer layer of the second polymer and a core of the second polymer having a cellular structure positioned between the substrate and the non-cellular outer layer.

11. The method of claim 10 wherein injection molding the second polymer further comprises:
mixing a blowing agent with the second polymer; and
allowing the blowing agent to form the cellular structure of the core.

12. The method of claim 10 wherein the first polymer is injection molded in a first injection-molding cavity of a mold assembly and the second polymer is injection molded in a second injection-molding cavity in the mold assembly, and further comprising:
removing the substrate from the first injection-molding cavity; and
placing the substrate into the second injection-molding cavity for injection molding of the second polymer.

13. A method of restraining an occupant of a vehicle passenger cabin with an airbag deployed upon an occurrence of a measurable vehicle condition, comprising:
detecting the occurrence of the measurable vehicle condition;
discharging an inflation fluid into a core of a covering on a substrate located inside the vehicle passenger cabin in response to the measurable vehicle condition so that the core loses cohesion and defines a space between the substrate and an elastic outer skin of the covering; and
filling the space with the inflation fluid so that the outer skin elastically expands into the vehicle passenger cabin and defines the airbag cushion at a position that restrains the occupant.

14. The method of claim 13 wherein a portion of the outer skin is coupled with an inner skin of the covering that remains attached to the substrate when the airbag cushion is inflated.
